(19) United States
(12) Patent Application Publication
(10) Pub. No.: US 2025/0240101 A1
(43) Pub. Date: Jul. 24, 2025

(54) RECEIVER DEVICE FOR PULSE AMPLITUDE MODULATION SIGNALS

(71) Applicant: HUAWEI TECHNOLOGIES CO., LTD., Shenzhen (CN)

(72) Inventors: Nebojsa Stojanovic, Munich (DE); Youxi Lin, Wuhan (CN); Maxim Kuschnerov, Munich (DE)

(73) Assignee: HUAWEI TECHNOLOGIES CO., LTD., Shenzhen (CN)

(21) Appl. No.: 19/173,807

(22) Filed: Apr. 8, 2025

Related U.S. Application Data
(63) Continuation of application No. PCT/CN2023/123674, filed on Oct. 10, 2023.

(30) Foreign Application Priority Data
Oct. 10, 2022 (WO) PCT/EP2022/078128
Nov. 18, 2022 (WO) PCT/EP2022/082379

(51) Int. Cl. H04B 10/61

(52) U.S. Cl. CPC H04B 10/613; H04B 10/615; H04B 10/616

(57) ABSTRACT

This disclosure relates to a receiver device for pulse amplitude modulation (PAM) signals. The receiver device calculates a transmitter dispersion eye closure quaternary (TDECQ). The receiver device first obtains a signal, wherein the signal is based on a PAM signal sent by a transmitter device over a channel to the receiver device, and filters the obtained signal. Further, the transmitter device equalizes the filtered signal using a FFE with multiple taps, and filters the equalized signal output by the FFE using a 2-tap post filter, wherein high frequency noise caused by the FFE is compressed. The receiver device applies a Max-Log-Map (MLM) algorithm on the filtered signal output by the 2-tap post filter, reconstructs a signal constellation of the PAM signal based on the result of the MLM algorithm, and calculates a TDECQ based on the reconstructed signal constellation.

### CROSS-REFERENCE TO RELATED APPLICATIONS

This application is a continuation of International Application No. PCT/CN2023/123674, filed on Oct. 10, 2023, which claims priority to International Patent Application No. PCT/EP2022/078128, filed on Oct. 10, 2022, and International Patent Application No. PCT/EP2022/082379, filed on Nov. 18, 2022. All of the aforementioned patent applications are hereby incorporated by reference in their entireties.

### TECHNICAL FIELD

The present disclosure relates to a receiver device and a receiving method for receiving a pulse amplitude modulation (PAM) signal sent by a transmitter device over a channel. The receiver device and the receiving method of this disclosure are configured to obtain a transmitter dispersion eye closure quaternary (TDECQ), which indicates a quality of the transmission of the PAM signal by the transmitter device over the channel.

### BACKGROUND

The latest generation of high-performance optical interconnects used in data communications deploys a 4-level PAM format (PAM4). One of the main system-level signal quality metrics is the TDECQ. In channels without chromatic dispersion (CD), the transmitter eye closure quaternary (TECQ) is also used. The difference between these two values provides CD penalties.

The TDECQ quantifies penalties coming from impairments, which can either be equalized or cannot be equalized, using a reference receiver. The TDECQ is a measure of an optical transmitter's vertical eye closure when transmitting a PAM signal through a worst case optical channel. The TDECQ may be as measured through an optical to electrical converter (O/E) and an oscilloscope with combined frequency response, and may be equalized with a reference equalizer. The reference receiver and reference equalizer may be implemented in software, or may be part of an oscilloscope or other receiver device.

### SUMMARY

An exemplary optical interconnect, over which a pattern is sent from an optical transmitter through a worst case optical channel to a TDECQ tester is shown in FIG. 1(a).

The TDECQ tester comprises a reference receiver and a TDECQ algorithm. The reference receiver converts the received optical signal into an electrical signal, and filters the electrical by a fourth-order Bessel-Thomson (BT4) filter. The TDECQ algorithm then finds an optimal 5-tap feed-forward equalizer (FFE), given the BT4 shaped receiver noise. FIG. 1(a) also depicts reference points for adding noise σ_{G} and σ_{eq} and a noise enhancement factor C_{eq}. The TDECQ algorithm, which is connected to the reference receiver, finds the largest input referred receiver noise, σ_{G}, that causes a signal enhancement ratio (SER) equal to the target SER (TSER) of 4.8×10⁻⁴ (KP4 forward error correction (FEC) limit).

As shown in FIG. 1(b), the equalizer samples at two sampling points at a distance of 0.1 UI, and the best sampling phase (where the TDECQ is smallest) is found. There are two sampling phases and the TDECQ with the worst value is selected. The TEDCQ is calculated by

$$TDECQ = 10 log ( {C}_{e q} \frac{{σ}_{i d e a l}}{{σ}_{e q}} ) = 10 log ( \frac{OMA}{6} \frac{1}{{Q}_{t} R} )$$

wherein R is the root mean square (RMS) noise that could be added by a receiver and Qₜ is 3.414 consistent with the bit error rate (BER) and TSER for a Gray coded PAM4. The whole procedure is carried out in blind mode, so that the TDECQ is only used to quantify the transmitter quality but not the BER or SER. The calculation of R is described, for example, in the IEEE Standard for Ethernet (IEEE Std. 802.3, 2018). The optical modulation amplitude (OMA) is the highest amplitude level.

However, the above-described procedure brings challenges. For example, high-speed optical interconnects require very powerful digital signal processing (DSP), which includes maximum likelihood sequence estimator (MLSE). As another example, for new higher-speed transceiver generations, an advanced and more sophisticated TDECQ calculation is required.

In view of this, an objective of this disclosure is to provide an improved TDECQ calculation.

This and other objectives are achieved by this disclosure as described in the enclosed independent claims. Advantageous implementations are further defined in the dependent claims.

A first aspect of this disclosure provides a receiver device for PAM signals the receiver device being configured to: obtain a signal, wherein the signal is based on a PAM signal sent by a transmitter device over a channel to the receiver device; filter the obtained signal;
equalize the filtered signal using a FFE with multiple taps; filter the equalized signal output by the FFE using a 2-tap post filter, wherein high frequency noise caused by the FFE is compressed; apply a Max-Log-Map (MLM) algorithm on the filtered signal output by the 2-tap post filter; reconstruct a signal constellation of the PAM signal based on the result of applying the MLM algorithm; and calculate a TDECQ based on the reconstructed signal constellation of the PAM signal.

The receiver device of the first aspect provides improved TDECQ calculation. For example, the receiver device can calculate an accurate TDECQ. Instead of using the output of a FFE to calculate the TDECQ, the receiver device of the first aspect uses the output of the signal (constellation) reconstruction to calculate the TDECQ.

In an implementation form of the first aspect, the PAM signal sent by the transmitter device is an optical signal, wherein the obtained signal is an electrical signal, and wherein the receiver device comprises a photo detector to convert the optical signal into the electrical signal.

The PAM signal may, for example, be a PAM4 signal. The optical channel may be a fiber.

In an implementation form of the first aspect, the receiver device is configured to filter the obtained signal using a low-pass filter.

The filter may be an H-BT4 filter, but can be any kind of low-pass filter.

In an implementation form of the first aspect, the FFE is configured to recover PAM levels included in the PAM signal by equalizing the filtered signal.

This reduces distortions in the obtained signal and the filtered signal, and thus leads to an improved performance of the receiver device.

In an implementation form of the first aspect, the FFE is configured to perform a blind FFE algorithm to equalize the filtered signal.

The blind FFE algorithm may lead to improved decisions at the receiver device. For example, the FFE may find the taps in a blind mode. For instance, a decision-directed least-mean square mode (DD-LMS) may be used in the blind mode, but also any other blind method.

In an implementation form of the first aspect, the filtering of the equalized signal comprises a linear filtering of the equalized signal with the 2-tap post filter based on a filtering coefficient, wherein the filtering coefficient is determined in an iterative manner.

In an implementation form of the first aspect, the result of applying the Max-Log-Map algorithm on the filtered signal output by the 2-tap post filter comprises log probabilities for each PAM level of the PAM signal.

In an implementation form of the first aspect, the receiver device is configured to reconstruct the signal constellation of the PAM signal based on the log probabilities.

In an implementation form of the first aspect, the reconstructing of the signal constellation of the PAM signal comprises generating a PAM histogram representative of the PAM levels of the PAM signal.

In an implementation form of the first aspect, the receiver device is configured to calculate the TDECQ based on the PAM histogram.

In an implementation form of the first aspect, the receiver device is configured to calculate the TDECQ based further on noise, which is added to the reconstructed signal constellation of the PAM signal.

Adding the noise may allow scanning noise-dependent SER and find the noise amount that leads to a target SER. This noise amount may be used to calculate the TDECQ.

In an implementation form of the first aspect, the receiver device is configured to calculate the TDECQ comprising a 2-tap post filter parameter, CeqPF, which is equal to sqrt(1+α²)/(1+α). Incorporating the CeqPF results in improved accuracy of the TDECQ calculation.

In an implementation form of the first aspect, the TDECQ is indicative of a quality of the transmission of the PAM signal by the transmitter device.

In an implementation form of the first aspect, the receiver device comprises a sampling scope, which is configured to perform the equalizing of the filtered signal, the filtering of the equalized signal, the applying of the MLM algorithm, the reconstructing of the signal constellation, and the calculating of the TDECQ.

A second aspect of this disclosure provides a receiving method for pulse amplitude PAM signals, the receiving method comprising: obtaining a signal, wherein the signal is based on a PAM signal sent by a transmitter device over a channel; filtering the obtained signal; equalizing the filtered signal using a feed forward equalization with multiple taps; filtering the equalized signal using a 2-tap filtering, wherein high frequency noise caused by the feed forward equalization is compressed; applying a MLM algorithm on the 2-tap filtered signal; reconstructing a signal constellation of the PAM signal based on the result of applying the MLM algorithm; and calculating a TDECQ based on the reconstructed signal constellation of the PAM signal.

In an implementation form of the second aspect, the PAM signal sent by the transmitter device is an optical signal, wherein the obtained signal is an electrical signal, and wherein the receiving method comprises converting the optical signal into the electrical signal.

In an implementation form of the second aspect, the receiving method comprises filtering the obtained signal using a low-pass filter.

In an implementation form of the second aspect, the feed forward equalization recovers PAM levels included in the PAM signal by equalizing the filtered signal.

In an implementation form of the second aspect, the feed forward equalization comprises performing a blind feed forward equalization algorithm to equalize the filtered signal.

In an implementation form of the second aspect, the 2-tap post filtering of the equalized signal comprises a linear filtering of the equalized signal based on a filtering coefficient, wherein the filtering coefficient is determined in an iterative manner.

In an implementation form of the second aspect, the result of applying the MLM algorithm on the filtered signal comprises log probabilities for each PAM level of the PAM signal.

In an implementation form of the second aspect, the receiving method device comprises reconstructing the signal constellation of the PAM signal based on the log probabilities.

In an implementation form of the second aspect, the reconstructing of the signal constellation of the PAM signal comprises generating a PAM histogram representative of the PAM levels of the PAM signal.

In an implementation form of the second aspect, the receiving method comprises calculating the TDECQ based on the PAM histogram.

In an implementation form of the second aspect, the receiving method comprises calculating the TDECQ based further on noise, which is added to the reconstructed signal constellation of the PAM signal.

In an implementation form of the second aspect, the TDECQ is indicative of a quality of the transmission of the PAM signal by the transmitter device.

In an implementation form of the second aspect, the receiving method is performed using a sampling scope, which performs the equalizing of the filtered signal, the filtering of the equalized signal, the applying of the MLM algorithm, the reconstructing of the signal constellation, and the calculating of the TDECQ.

The method of the second aspect and its implementation forms achieve the same advantages as described above for the receiver device of the first aspect.

A third aspect of this disclosure provides a computer program comprising instructions which, when the program is executed by a computer, cause the computer to perform the method according to the second aspect or any implementation form thereof.

A fourth aspect of this disclosure provides a non-transitory storage medium storing executable program code which, when executed by a processor, causes the method according to the second aspect or any of its implementation forms to be performed.

The aspects and implementation forms (solutions) of this disclosure differ from other exemplary solutions at least in the following. The exemplary solutions typically use a simple DSP that consists of a linear FFE. This equalizer structure is even preferred in commercial systems. The FFE may have more taps, including nonlinear taps, to improve performance. However, next-generation high-speed transceivers will include MLSE, and may need to have transmitter quality estimation based on MLSE, as this can deal with strong intersymbol interference (ISI).

The MLM-based TDECQ of this disclosure includes the FFE and the MLM algorithm to reconstruct the signal constellation of the PAM signal, which will be used for the TDECQ calculation. Instead, the exemplary solutions calculate the TDECQ directly from the FFE output. This disclosure may perform the transmitter quality estimation for various PAM systems, for example, PAM4 systems. The PAM signal may be a PAM4 signal.

The solution of this disclosure provides the benefit that a more advanced algorithm can be used to detect the transmitted signal, and the requirement on transmitter components can be relaxed (more flexibility, which eventually may reduce the system cost). It also enables comparison of different transmitters, in order to fulfil future standards.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of specific embodiments in relation to the enclosed drawings, in which

FIG. 1 shows in (a) an exemplary solution for calculating TDECQ, and in (b) an exemplary PAM4 eye diagram used for TDECQ calculation.

FIG. 2 shows in (a) a receiver device for receiving PAM signals according to this disclosure, and in (b) another receiver device according to this disclosure implemented in an optical transmission system.

FIG. 3 shows an exemplary receiver device according to this disclosure implemented in an optical transmission system.

FIG. 4 shows an example of recovered PAM levels of a PAM signal sent by a transmitter device to a receiver device according to this disclosure.

FIG. 5 shows results for a receiver device according to this disclosure, in particular, histogram levels for three competing group of symbols, 01,12, and 23.

FIG. 6 shows results for a receiver device according to this disclosure, in particular, histograms of the FFE and MLM blocks.

FIG. 7 shows results for a receiver device according to this disclosure, in particular, a histogram of the post filter noise and other histograms.

FIG. 8 shows results for a receiver device according to this disclosure, in particular, a noise enhancement after the MLM block.

FIG. 9 shows results for a receiver device according to this disclosure, in particular, of multiplying noise and CF histogram bins, summing them up, and selecting the noise with SER equal to the target SER.

FIG. 10 shows results for a receiver device according to this disclosure, in particular, histograms after FFE and MLM for four transmitter cases.

FIG. 11 shows results for a receiver device according to this disclosure, in particular, SER vs. EbN0 and the TDECQ.

FIG. 12 shows results for a receiver device according to this disclosure, in particular, for off-line data from two different transmitter devices Tx1 and Tx2.

FIG. 13 shows a method for receiving PAM signals according to this disclosure.

### DETAILED DESCRIPTION OF EMBODIMENTS

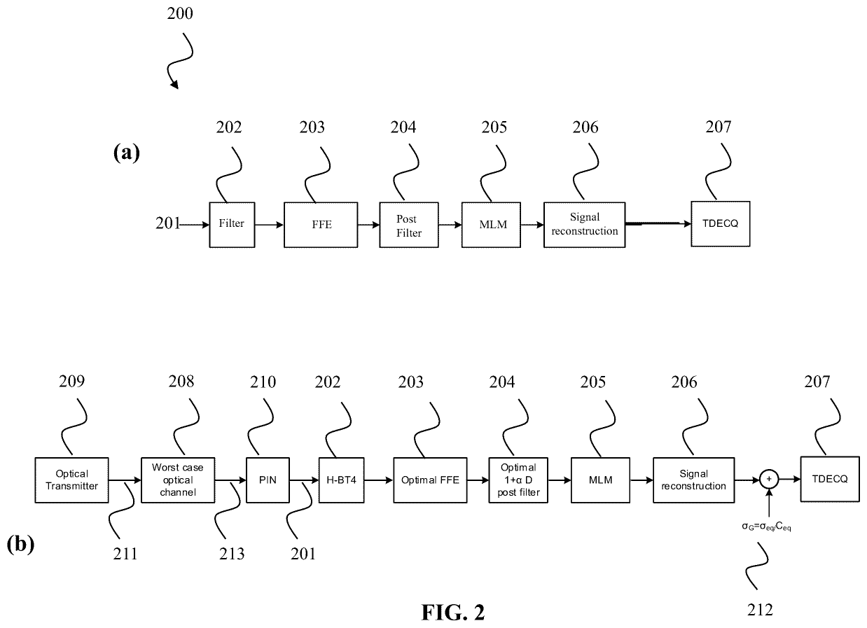

FIGS. 2(a) and 2(b) show a receiver device 200 according to this disclosure. The receiver device 200 shown in FIG. 2(b) is a further development of the receiver device 200 shown in FIG. 2(a), and is shown implemented in an optical transmission system comprising a transmitter device 209. The receiver device 200 of this disclosure is configured to receive PAM signals, for instance, PAM4 signals. The receiver device 200 of this disclosure can calculate a TDECQ for a received signal (received from a channel 208) that is based on a PAM signal (e.g., PAM4 signal) that the transmitter device 209 sent to the receiver device 200 over the channel 208.

A shown in FIG. 2(a) the receiver device 200 of this disclosure is configured to obtain a signal 201, wherein the signal 201 is based on the PAM signal sent by the transmitter device 209. The signal 201 may be an electrical signal, whereas the PAM signal may be an optical signal.

The receiver device 200 is further configured to filter the obtained signal 201, by using a filter 202, for example, using a low-pass filter. Then, the receiver device 200 is configured to equalize the filtered signal by using a FFE 203 with multiple taps. The receiver device 200 is further configured to filter the equalized signal, which is output by the FFE, by using a 2-tap post filter 204. The 2-tap post filter 204 is configured to compress high frequency noise caused by the FFE 203.

The receiver device 200 is further configured to apply a MLM algorithm 205 on the filtered (equalized) signal, which is output by the 2-tap post filter 204. Then, the receiver device 200 is configured to reconstruct a signal constellation 206 of the PAM signal based on the result of applying the MLM algorithm 205. Further, the receiver device 200 is configured to calculate a TDECQ 207 based on the reconstructed signal constellation (e.g., in a signal reconstruction block 206) of the PAM signal, which was obtained using MLM.

The receiver device 200 of FIG. 2(b) is configured based on the receiver device 200 of FIG. 2(b), and may perform the same steps. Same elements in FIG. 2(a) an FIG. 2(b) are labelled with the same reference signs and may function likewise. More optional details are shown for the receiver device 200 of FIG. 2(b).

As shown in FIG. 2(b), the PAM signal 211 is transmitted by the transmitter device 209, for instance, by an optical transmitter. The PAM signal 211 in this case is accordingly an optical signal. The PAM signal 211 is sent over a channel 208, which may be considered to be a worst case optical channel. After the channel 208, the optical signal 213 is received by a PIN based photo detector 210 of the receiver device 200, which is configured to convert the optical signal 213 (corresponding to the optical PAM signal 211 after the channel 208) into the obtained signal 201, which is an electrical signal. The electrical signal can be processed in the receiver device 200.

The obtained electrical signal 201 may be filtered by an H-BT4 filter of the receiver device 200, and the filtered signal output by the H-BT4 filter may then be equalized by an optimal FFE 203 of the receiver device 200. The equalized signal may then be further filtered by an optimal linear filter, as the post filter 204, wherein the filtering is based on a filtering coefficient α. The filtered signal may then be input into the MLM algorithm 205 (e.g., a MLM calculation block), and the output of the MLM algorithm 205 is used by a signal the reconstruction block 206 to reconstruct the signal constellation of the PAM signal 211. Then, noise 212 can be added to the reconstructed signal constellation of the PAM signal 211, and finally the TDECQ 207 is calculated based on the on the reconstructed signal constellation of the PAM signal 211 with the added noise 212.

The receiver device 200 may comprise a processor or processing circuitry (not shown) configured to perform, conduct or initiate the various operations of the receiver device 200 described herein. The processing circuitry may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. The receiver device 200 may further comprise memory circuitry, which stores one or more instruction(s) that can be executed by the processor or by the processing circuitry, in particular under control of the software. For instance, the memory circuitry may comprise a non-transitory storage medium storing executable software code which, when executed by the processor or the processing circuitry, causes the various operations of the receiver device 200 to be performed. In one embodiment, the processing circuitry comprises one or more processors and a non-transitory memory connected to the one or more processors. The non-transitory memory may carry executable program code which, when executed by the one or more processors, causes the receiver device 200 to perform, conduct or initiate the operations or methods described herein.

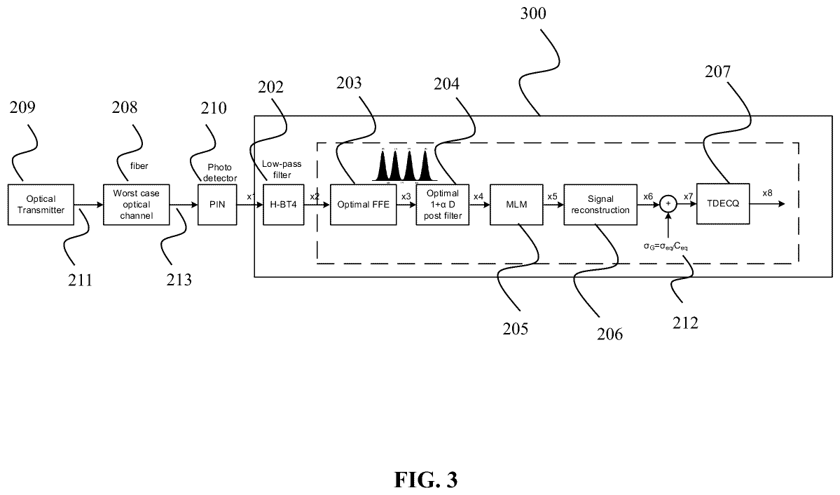

FIG. 3 shows a receiver device 200 according to this disclosure, which builds on the receiver device 200 shown in FIG. 2(a) and FIG. 2(b), respectively. Same elements are labelled with the same reference signs, and may function similarly or likewise.

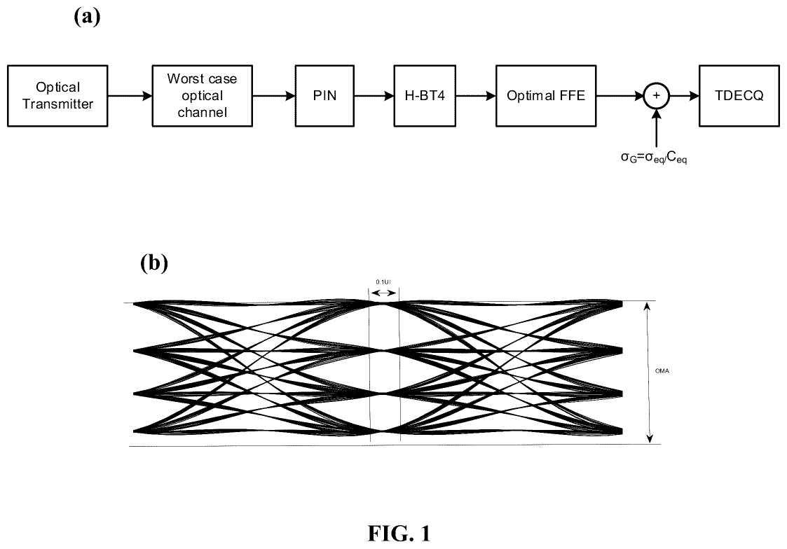

Overall, FIG. 3 presents a novel TDECQ obtaining procedure based on MLM. Notably, the receiver device 200 shown in FIG. 3 may also be based on the system shown in FIG. 1(a), wherein the receiver device 200 is extended over the receiver in FIG. 1(a) at least by the 2-tap post filter 204, the MLM algorithm 205 (a simplified BCJR algorithm), the signal reconstruction block 206, and the TDECQ calculation 207 based on the output of the signal reconstruction block 206.

Notably, the receiver device 200 can be used for any PAM modulation format, but this disclosure focuses specifically on PAM4, as it will be likely the modulation format used in the next generation of high-speed optical transceivers. The TDECQ 207 is used to quantify the quality of the PAM4 transmitter device 209, but it could also be referred to as the transmitter quality parameter that includes any transmission scenario and any modulation format. The value of the TDECQ 207 may indicate the transmitter quality. Thus, the transmitter quality can be quantified by the TDECQ 207, and one may check whether this value is below a maximum allowed value (e.g., TDECQmax) that will be defined by standards.

The optical signal 213 (e.g., received from a fiber as the channel 208) is received by the photo detector 210 of the receiver device 200 (e.g., implemented by a photo diode). The obtained signal x1 (which corresponds to the obtained signal 201 shown in FIG. 2(a) and FIG. 2(b), respectively) after the photo detector 210 is an electrical signal x1 that is captured (e.g., sampled and stored), for instance, by an instrument 300 like a sampling scope.

The captured signal x1 (e.g., several million samples) may be processed by a software program that is run in the receiver device 200. The signal x1 (e.g., its stored samples) are low-pass filtered (by the H-BT4 filter 202) in the receiver device 200 of FIG. 3, in order to get rid of out-band noise, as the scope can have a large bandwidth and sampling rate.

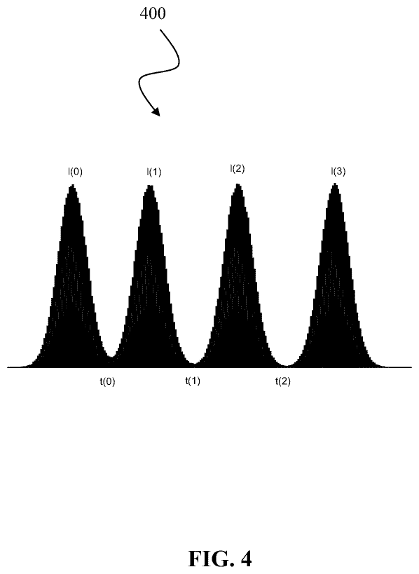

The signal x2 after the H-BT4 202 is equalized by a FFE 203 than can have N taps. The signal x2 may be distorted and one cannot see clear PAM levels, particularly, in a histogram based on signal x2. However, the signal x3 after the FFE 203 is clear and one can see, for instance, four PAM4 levels as shown in FIG. 4. Notably, a blind FFE algorithm may be used by the FFE 203 to get better decisions after the FFE 203.

The signal x3 after the FFE 203 is filtered by the 2-tap linear post filter 204. The post filter is defined by its transfer function 1+αD, where D denotes a delay of symbol period and α is a filter coefficient. Deriving the value of the filtering coefficient α may be done in an iterative manner. After the post filter 204 (may also be referred to as a noise decorrelation filter), the signal x4 is processed by the MLM block (performing the MLM algorithm 205) to get improved decisions. This MLM block may generate log probabilities for each PAM level. The result of the MLM algorithm 205 is the signal x5. The post-filter can include more taps. For example, 3-tap post filter involving three FFE output samples is defined by 1+αD+βD², where D² denotes 2-symbol period delay.

The signal x5 may contain four log probability values, and they are used to generate a PAM histogram representative of the PAM levels, e.g. PAM4 levels 400 shown in FIG. 4, of the PAM signal 211. That is, the reconstructing of the signal constellation of the PAM signal 211 at the signal reconstruction block 206 may comprise generating the PAM histogram representative of the PAM levels of the PAM signal 211. The signal x6 comprises the reconstructed signal constellation, e.g., samples that can be used to represent PAM signal with the PAM levels.

The receiver device 200 of this disclosure can then use the output signal x6 of the signal reconstruction block 206 to calculate the TDECQ 207. As the signal x6 is similar to the signal x3, the TDECQ calculation can be similar to the exemplary TDECQ calculation shown in FIG. 1(a). The TDECQ algorithm is used to calculate TDECQ 207. The TDECQ algorithm used in FIG. 1(a) may thereby be modified. In addition, a noise 212 may be defined in front of the TDECQ calculation block. The signal x7 is the signal x6 with the added noise 212. The TEDCQ 207 is then calculated on the signal x7, i.e., based on the reconstructed signal constellation x6 with added noise 212. The TDECQ value may be output as signal x8.

In the following, further exemplary implementation details for the receiver device 200, as presented in the FIGS. 2(a), 2(b) and 3, are described.

The FFE 203 may use N linear taps to recover the PAM4 levels of the received PAM4 signal 213 coming from the ISI channel 208. N may be an odd number, and N=7 is exemplarily used in the rest of the disclosure. For N=7, the starting FFE taps may be c=0001000, i.e., all taps may be set to zero and the central tap (N−1)/2+1 may be set to 1. The FFE 203 may then follows the next steps:
1. The signal x2 before the FFE 203 is normalized by x=g*(x2−dc), dc=mean(x2) to enable fast FFE acquisition. The FFE 203 transforms unipolar to bipolar signals to avoid low-frequency components suppression. The parameter g is selected to enable fast acquisition and low FFE output noise.
2. The FFE 203 finds taps c(i), i=0, 1, . . . , N−1 in a blind mode. A gradient algorithm quantizes the output signal to levels l=−3, −1, 1, 3, and thresholds t=−2, 0, 2 to adjust the taps by using decisions in decision-directed least-mean square mode (DD-LMS). The DD-LMS can, however, be replaced by other blind methods.
3. After stabilizing the FFE taps, the PAM4 output levels are found by histogram analyses. The new levels are l(i), with i=0, 1, 2, 3, and the new thresholds are t(i), with i=0, 1, 2.
4. The FFE 203 is run with the new levels. The steps 3 and 4 can be repeated several times, until the taps become stable.
5. After stabilizing the FFE taps, the output signal x3 is adjusted by

$$x 3 = x 3 + g * d c * sum ( c ) .$$

6. The output signal histogram is analyzed to find levels l and thresholds t. Note that, for example, OMA=l3.

The post filter 204 transforms the FFE output signal x3 into signal x4 by

$$x 4 ( k ) = x 3 ( k ) + α * x 3 ( k - 1 ) .$$

The parameter α is calculated by

$$α = - mean ( error ( 1 : end - 1 ) . * error ( 2 : end ) ) / mean ( error . \hat{} 2 ) ,$$

wherein error=qsym−y and qsym are quantized symbols with thresholds t and levels l. The error is calculated by using the FFE outputs that might be unreliable and the alpha (α) estimation can be less accurate at high BER values. As the FFE 302 acts as high-pass filter, the post filter 204 compresses the FFE noise at high frequencies caused by the FFE noise enhancement.

The MLM algorithm 205 may deliver more reliable decisions. The MLM algorithm 205 may be run several times to get a more accurate a value that will be used in the final MLM run. The MLM outputs PAM4 symbol log probabilities. The best symbol can be selected to calculate the error. The MLM output symbols x5 may comprise symMLM and error=l(symMLM)−x3.

The MLM algorithm, in particular, calculates log probabilities at symbol time i for each of four PAM4 symbol candidates, lp(i,j), j=0, 1, 2, 3. It may for example use the algorithm described in ‘Lucian Andrei Perişoară, and Rodica Stoian, “The Decision Reliability of MAP, Log-MAP, Max-Log-MAP and SOVA Algorithms”, INTERNATIONAL JOURNAL OF COMMUNICATIONS, Issue 1, Volume 2, 2008’, with branch probabilities bp(I,k)=(w(i)−m(k))² (Euclidian distance). The signal x4 is

$$x 4 ( k ) = x 3 ( k ) + α * x 3 ( k - 1 ) = ( 1 + α ) * s 1 ( k ) + n ( k ) + α * n ( k - 1 ) = x {3}_{0} ( k ) + nx 3 ( k ) ,$$

where sl is transmitted symbol level (sl=l(n), n=0, 1, 2, 3) and nx3 is post filter noise.

When a single trellis stage is considered and two symbols s(i) and s(i+1), i=0,1,2,3 and s(i)=i, compete the log-likelihood ratio llr is equal to llp(i)=lp(i)−lp(i+1). By collecting events where either s(i) or s(i+1) symbol is decided, one can get histogram (positive and negative histograms grouped in single one) with maximum levels at positions ll(i)=±[l(i+1)−l(i)]², with the threshold at 0, and noise with standard deviation σ(i)=2*[l(i+1)−l(i)].

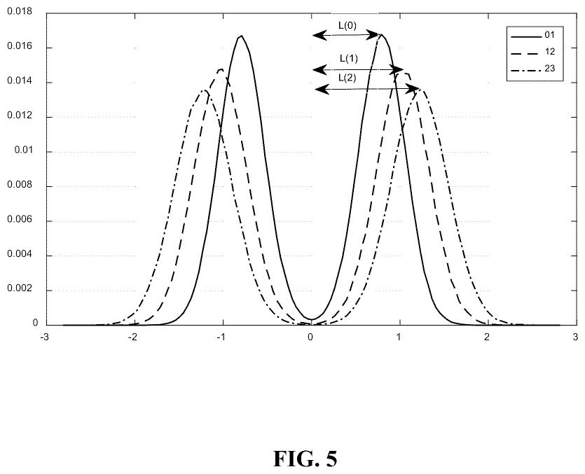

Normally, the MLM algorithm 205 uses long sequence to get lp values and the histogram will have slightly different values than predicted by a single trellis stage. The final histogram levels (values with the highest probability) will be ±L(i), I=0, 1, 2 for three competing group of symbols, 01,12, and 23, as shown in FIG. 5.

The previous histograms (llp(i)=lp(i)−lp(i+1)) are obtained by selecting lp where either the symbol s(i) or the symbols s(i+1) is the best one. To calculate TDECQ 207, one wants to get PAM4 histograms after the MLM block based on lp values. The FFE output levels are l(i), I=0, 1, 2, 3. First, one wants to get the normalization factors nf for three group of histograms described earlier. The nf values may be calculated by nf(i)=[l(i+1)−l(i)]/2/L(i) so that the new levels are [l(i+1)−l(i)]/2.

Now, three groups of positions may be selected using sorting matrix b(i,j) for symbol at a position i where the first column value indicates the best symbol:
Group 1—all positions p0 where [b(i,0)=0 and b(i,1)=1] or [b(i,0)=1 and b(i,1)=0]
Group 2—all positions p1 where [b(i,0)=1 and b(i,1)=2] or [b(i,0)=2 and b(i,1)=1]
Group 3—all positions p2 where [b(i,0)=2 and b(i,1)=3] or [b(i,0)=3 and b(i,1)=2]

In the next step the llr vector is constructed by:

$$llr ( p 0 ) = nf ( 0 ) * [ lp ( p 0 , 0 ) - lp ( p 0 , 1 ) ] + t ( 0 )$$

$$llr ( p 1 ) = nf ( 1 ) * [ lp ( p 1 , 1 ) - lp ( p 1 , 2 ) ] + t ( 1 )$$

$$llr ( p 2 ) = nf ( 2 ) * [ lp ( p 2 , 2 ) - lp ( p 2 , 3 ) ] + t ( 2 )$$

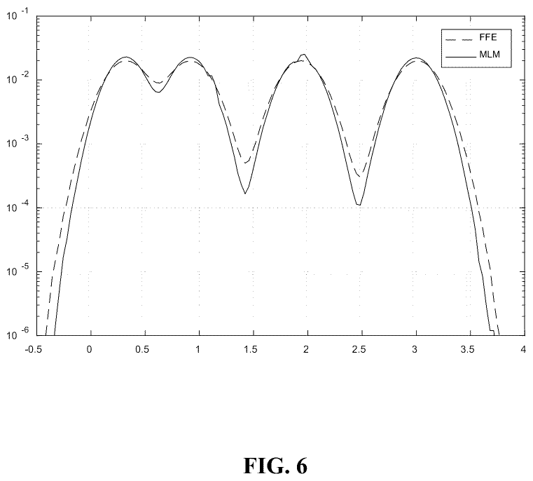

The signal reconstruction block 296 generates a signal x6 similar to the FFE output signal x3. The levels and thresholds are identical to those of the FFE output signal x3, but the noise amount is slightly different. The FFE and MLM histograms can be represented in the same FIG. 6 to visualize the effect of these blocks. The MLM effect on BER is visible.

The normalization based on a single trellis analyses requires normalization by nfST(i)=0.5/[l(i+1)−l(i)] however we did it by nf(i)=[l(i+1)−l(i)]/2/L(i). There are some excursions in the MLM histogram as it consists of three groups of llrs. This is irrelevant for the TDECQ accuracy as excursions are located around the PAM4 levels. Additionally the histograms may be normalized, so that OMA=3, without changing the final results.

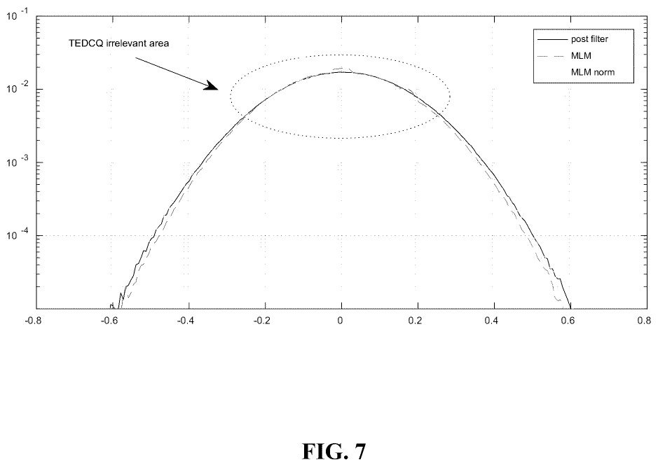

The post filter 204 shapes the FFE output noise by [1 α] coefficients. The histogram of the post filter noise is shown in FIG. 7. The noise after signal reconstruction (i.e. after MLM) can be a bit smaller than the post filer noise (MLM curve in FIG. 7; the MLM uses trellis search that further improve noise statistics). To achieve a more accurate TDECQ calculation, noise may be added in the TDECQ calculator and is additionally normalized by a factor nwf(i)=(l(i+1)−l(i))/sqrt(L(i)) that is usually less than 1. After the normalization, the MLM noise is very close to the post filter noise (MLM norm curve in FIG. 7). There are three SER values to be calculated (three thresholds). So, for each SER calculation a different noise is used i.e. white additive noise is corrected by Ceq and also by nwf(i).

One can note some deviations between histograms at high histogram values (bins close to 0; small noise region). They are irrelevant for TEDCQ calculation as the contribution of “strong” bins to SER is negligible.

The TDECQ calculation partly follows the calculation described in IEEE Standard for Ethernet, IEEE Std. 802.3, 2018. The difference is that the CeqMLSE parameter is calculated using FFE Ceq (CeqFFE) and nwf. The resulting CeqMLSE is CeqMLSE(i)=CeqFFE*nwf(i), i=0, 1, 2.

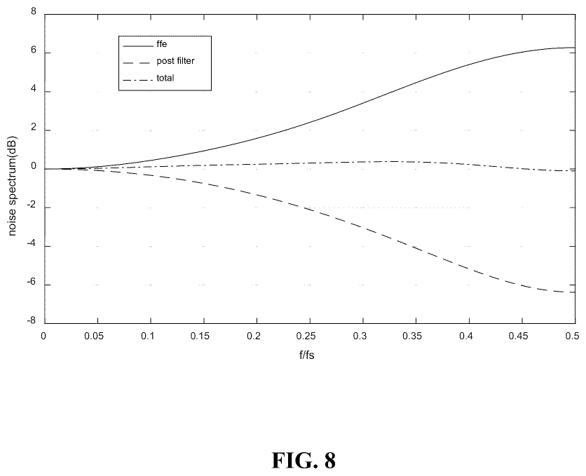

In an implementation, the resulting CeqMLSE is CeqMLSE(i)=CeqFFE·CeqPF·nwf(i), i=0, 1, 2. The 2-tap post filter parameter CeqPF is equal to sqrt(1+α²)/(1+α). The resulting noise enhancement after the MLM block is small as can be seen in FIG. 8.

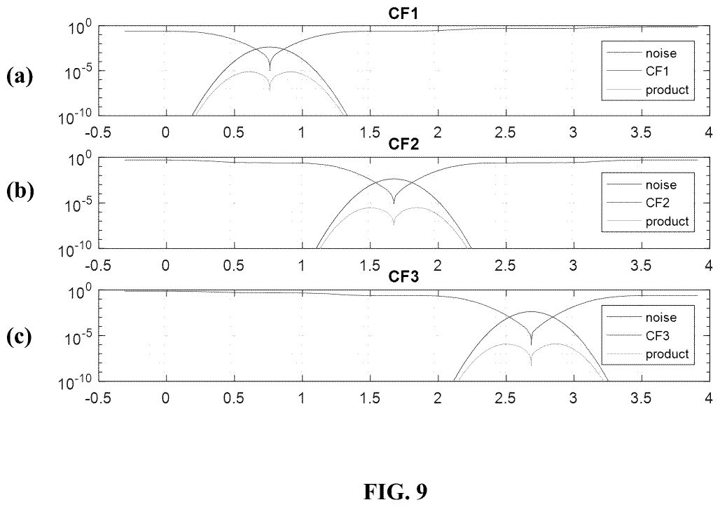

Three cumulative functions (CF) are obtained by methods described in IEEE Standard for Ethernet, IEEE Std. 802.3, 2018. Noise and CF histogram bins are multiplied, summed up, and the noise with SER equal to the target SER is selected as shown in FIG. 9.

SER_target is selected and the sigma (σ) search is applied to find sigma value that gives SER=SERtarget:

$$S E R = {\sum }_{i = 0}^{2} {\sum }_{j = - K}^{K - 1} C F ( i , j ) \frac{1}{C e q FFE \cdot nwf ( i ) \cdot σ} exp ( - \frac{{[ x ( k ) - t ( i ) ]}^{2}}{{2 [ CeqFFE \cdot nwf ( i ) \cdot σ ]}^{2}} ) Δ x .$$

or in an implementation

$$SER = {\sum }_{i = 0}^{2} {\sum }_{j = - K}^{K - 1} CF ( i , j ) \frac{1}{CeqFFE \cdot CeqPF \cdot nwf ( i ) \cdot σ} exp ( - \frac{{[ x ( k ) - t ( i ) ]}^{2}}{{2 [ CeqFFE \cdot CeqPF \cdot nwf ( i ) \cdot σ ]}^{2}} ) Δ x$$

The MLM histogram consists of 2K bins of width Δx. The value σₜ that corresponds to SER_target value is used for TDECQ calculation by

$$TDECQ ( dB ) = 10 log 10 ( \frac{OMA}{6 {σ}_{t} \cdot qfuncin v ( 2 \cdot SER\_target / 3 ) \cdot min ( nwf )} )$$

where qfuncinv denotes inverse Q function.

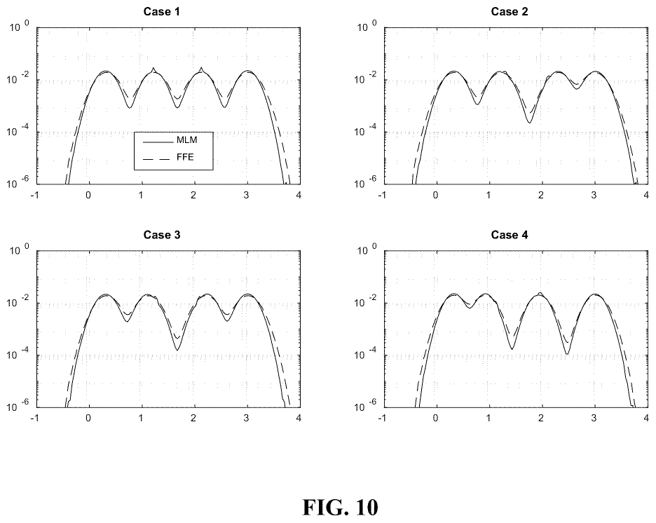

Four transmitter cases with narrow system bandwidth (α˜0.35; EbN0=17 dB, ER=10 dB) were simulated. The target SER was set to 4e−3. Histograms after FFE and MLM are shown in FIG. 10. The MLM improves performance (better histograms after MLM). The MLM signal reconstruction block provides histograms that show a bit irregular behavior around signal levels. However, this is irrelevant for the TDECQ accuracy as excursions are located around the PAM4 levels (small contribution to SER).

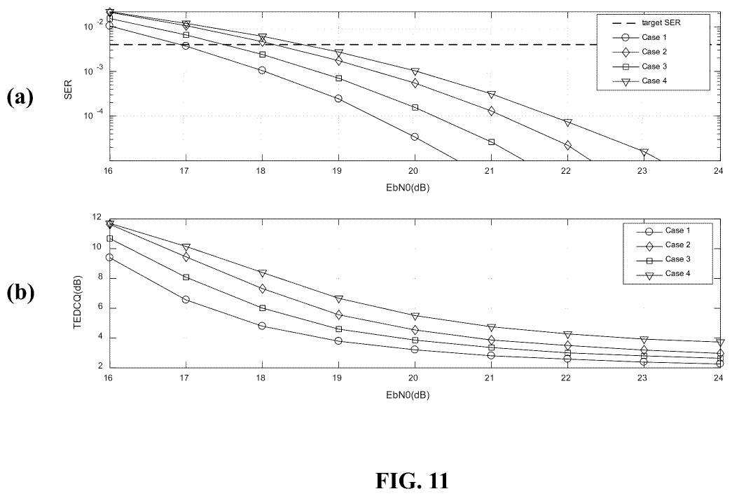

The first subplot in FIG. 11 shows SER vs EbN0 while the second subplot in FIG. 11 presents the TDECQ 207. The MLM-based TDECQ clearly differentiates better and worse channels. Better channels have smaller TDECQ as expected. This proves that the novel TDECQ 207 can be used to blindly estimate the quality of the transmitter device 209.

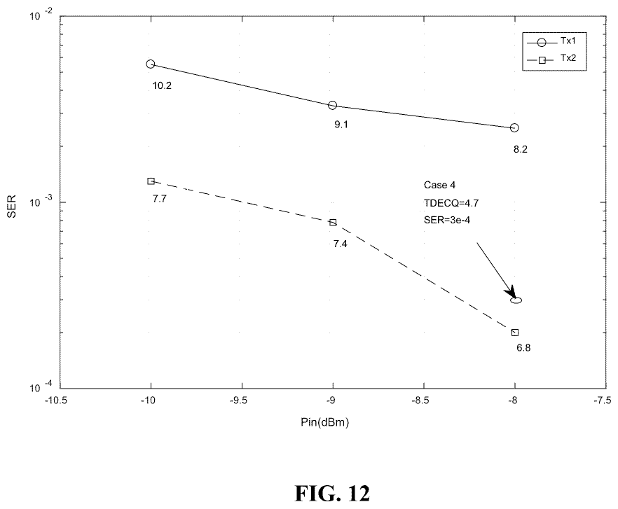

Off-line data from two different transmitter devices 209 was processed, Tx1 and Tx2, as shown in FIG. 12. Both of them have pattern dependent behavior but Tx2 behaves better. TDECQ values are indicated (below markers). The TDECQ clearly distinguishes the two transmitter devices without SER knowledge. In the same FIG. 12, a TEDCQ value of simulated Case 4 transmitter is added (TDECQ at SER=3e−4; Pin value does not correspond to EbN0 value; this is just for visualization). This transmitter device does not suffer from pattern dependencies and has better (lower) TDECQ value even at higher SER (3e−4) than Tx2 at SER=2e−4. This means that Tx2 will suffer more in the presence of noise than Case 4 transmitter.

Notably, the receiver device 200 and solutions of this disclosure can be used in measurement equipment to characterize the quality of optical transmitters. The disclosure can support standardization and optical transmitter selection.

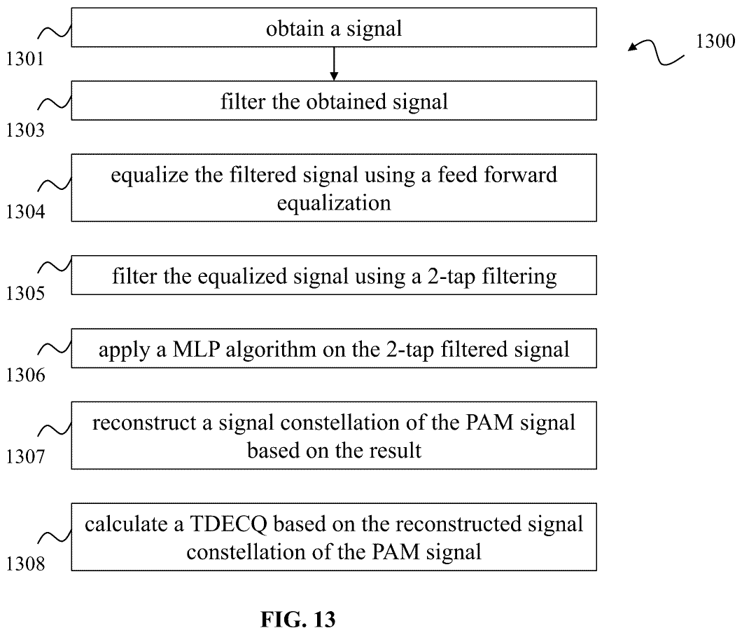

FIG. 13 shows a receiving method 1300 for PAM signals according to this disclosure. The method 1300 may be performed by the receiver device 200, and may be used for receiving PAM4 signals.

The method 1300 comprises a step 1301 of obtaining a signal 201, x1, wherein the signal 201, x1 is based on a PAM signal 211 sent by a transmitter device 209 over a channel 208. The method 1300 further comprises a step 1302 of filtering the obtained signal 201, x1, and then a step 1303 of equalizing the filtered signal x2 using a feed forward equalization (FFE 203) with multiple taps. The method 1300 further comprises a step 1304 of filtering the equalized signal x3 using a 2-tap filtering (2-tap filter 204), wherein high frequency noise caused by the feed forward equalization is compressed. Then, the method 1300 comprises a step 1305 of applying a MLM algorithm 205 on the 2-tap filtered signal x4, and afterwards a step 1306 of reconstructing a signal constellation x6 of the PAM signal 211 based on the result x5 of applying the MLM algorithm 205. Finally, the method 1300 comprises a step 1308 of calculating 1307 a TDECQ 207 based on the reconstructed signal constellation x6 of the PAM signal 211.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A receiver device for pulse amplitude modulation (PAM) signals, the receiver device being configured to:
obtain a signal, wherein the signal is based on a PAM signal sent by a transmitter device over a channel to the receiver device;
filter the obtained signal;
equalize the filtered signal using a feed forward equalizer (FFE) with multiple taps;
filter the equalized signal output by the FFE using a 2-tap post filter (204), wherein high frequency noise caused by the FFE is compressed;
apply a Max-Log-Map (MLM) algorithm on the filtered signal output by the 2-tap post filter;
reconstruct a signal constellation of the PAM signal based on the result of applying the MLM algorithm; and
calculate a transmitter dispersion eye closure quaternary (TDECQ), based on the reconstructed signal constellation of the PAM signal.

2. The receiver device according to claim 1, wherein the PAM signal sent by the transmitter device is an optical signal, wherein the obtained signal is an electrical signal, and wherein the receiver device comprises a photo detector to convert the optical signal into the electrical signal.

3. The receiver device according to claim 1, further configured to filter the obtained signal using a low-pass filter.

4. The receiver device according to claim 1, wherein the FFE is configured to recover PAM levels included in the PAM signal by equalizing the filtered signal.

5. The receiver device according to claim 1, wherein the FFE is configured to perform a blind FFE algorithm to equalize the filtered signal.

6. The receiver device according to claim 1, wherein the filtering of the equalized signal comprises a linear filtering of the equalized signal with the 2-tap post filter based on a filtering coefficient (α), wherein the filtering coefficient (α) is determined in an iterative manner.

7. The receiver device according to claim 1, wherein the result of applying the MLM algorithm on the filtered signal output by the 2-tap post filter comprises log probabilities for each PAM level of the PAM signal.

8. The receiver device according to claim 7, further configured to reconstruct the signal constellation of the PAM signal based on the log probabilities.

9. The receiver device according to claim 7, wherein the reconstructing of the signal constellation of the PAM signal comprises generating a PAM histogram representative of the PAM levels of the PAM signal.

10. The receiver device according to claim 9, further configured to calculate the TDECQ based on the PAM histogram.

11. The receiver device according to claim 1, configured to calculate the TDECQ based further on noise, which is added to the reconstructed signal constellation of the PAM signal.

12. The receiver device according to claim 1, wherein the TDECQ is calculated comprising a 2-tap post filter parameter, CeqPF, which is equal to sqrt(1+α²)/(1+α).

13. The receiver device according to claim 1, wherein the TDECQ is indicative of a quality of the transmission of the PAM signal by the transmitter device.

14. The receiver device according to claim 1, comprising a sampling scope, which is configured to perform the equalizing of the filtered signal, the filtering of the equalized signal, the applying of the Max-Log-Map algorithm, the reconstructing of the signal constellation, and the calculating of the TDECQ.

15. A receiving method for pulse amplitude modulation (PAM) signals, the receiving method comprising:
obtaining a signal, wherein the signal is based on a PAM signal sent by a transmitter device over a channel;
filtering the obtained signal;
equalizing the filtered signal using a feed forward equalization with multiple taps;
filtering the equalized signal using a 2-tap filtering, wherein high frequency noise caused by the feed forward equalization is compressed;
applying a MLM algorithm on the 2-tap filtered signal;
reconstructing a signal constellation of the PAM signal based on the result of applying the MLM algorithm; and
calculating a TDECQ based on the reconstructed signal constellation of the PAM signal.

16. A non-transitory computer program comprising instructions which, when the program is executed by a computer, cause the computer to perform the method according to claim 15.
